(19) United States
(12) Patent Application Publication
(10) Pub. No.: US 2013/0293041 A1
(43) Pub. Date: Nov. 7, 2013

(54) ELECTRIC MACHINE

(71) Applicants: Michael Steinbauer, Wald (AT); Gernot Fuckar, Graz (AT); Robert Berger, Strallegg (AT); Andreas Nimmervoll, Ramsau (AT); Aldo Bregant, Graz (AT)

(72) Inventors: Michael Steinbauer, Wald (AT); Gernot Fuckar, Graz (AT); Robert Berger, Strallegg (AT); Andreas Nimmervoll, Ramsau (AT); Aldo Bregant, Graz (AT)

(21) Appl. No.: 13/988,341

(22) PCT Filed: Nov. 17, 2011
(86) PCT No.: PCT/EP2011/070335

§ 371 Date: Jul. 5, 2013

(30) Foreign Application Priority Data
Nov. 18, 2010 (AT) 1911/2010

(51) Int. Cl. H02K 9/00

(52) U.S. Cl. CPC H02K 9/005
USPC 310/52

(57) ABSTRACT

An electric machine for a current generating unit configured to extend the range of an electric vehicle. The electric machine includes a cylindrical housing part produced by casting, which is configured to accommodate a stator and a rotor. The cylindrical housing part contains at least one cooling channel arrangement through which a coolant flows.

### CROSS-REFERENCE TO RELATED APPLICATIONS

The present application is a National Stage Application of PCT International Application No. PCT/EP2011/070335 (filed on Nov. 17, 2011), under 35 U.S.C. §371, which claims priority to Austrian Patent Application No. A 1911/2010 (filed on Nov. 18, 2010), which are each hereby incorporated by reference in their respective entireties.

### TECHNICAL FIELD

The invention relates to an electric machine, especially for a current generating unit for extending the range of an electric vehicle, comprising a cylindrical housing part, especially produced by casting, for accommodating a stator and a rotor, said housing part containing at least one cooling channel arrangement through which a coolant flows in a meandering manner.

### BACKGROUND

DE 100 22 146 A1 describes a stator with cooling tubes for an electric machine with rotating internal rotor, which stator comprises at least electric core stack and several cooling tubes arranged by means of encapsulation, with the cooling tubes being embedded in a casting body which is formed by casting of heat-conducting material and which rests on the core stack and/or is comprised by the same.

A cast moulded part of an electric motor is known from EP 0 899 852 A1. A stator frame of an electric motor is arranged as a cast moulded part with at least one axially extending internal rib of the housing which extends outside of the direct connection of the two face sides of the stator housing and/or is meandering or sinusoidal in the axial direction.

An electric motor with a cooling spiral is further known from DE 101 31 119 A1, which is arranged as a meandering planiform structure and consists of material that conducts heat very well and of deflections made of plastic.

In the case of housing parts that are produced especially by means of aluminium die-casting methods, a meandering configuration of the cooling channels which is advantageous for optimal heat dissipation can hardly be realised or only with difficulty with increased effort in the die-casting.

### SUMMARY

It is the object of the invention to avoid these disadvantages and to achieve optimal cooling in an electric machine in the simplest possible way.

This is achieved in accordance with the invention in such a way that the cooling channel arrangement comprises a plurality of essentially parallel cooling chambers which extend substantially in the axial direction of the electric machine, which are preferably cast simultaneously and which are provided with an open configuration on at least one first front side of the housing part, with each cooling chamber being defined by walls preferably extending substantially in the axial direction, and that a deflecting device which is spaced from the walls is introduced into at least one cooling chamber from the first front side.

The deflecting device is preferably formed by a plug and/or a guide element. The deflecting devices formed by the plug and/or guide ribs can be inserted in the axial direction into the cooling chambers in order to enable a meandering deflection of the coolant.

It is especially advantageous if the deflecting device is detachably arranged in the cooling chamber, with preferably the walls being spaced in the axial direction from the front side.

In order to achieve a sufficient cooling effect, deflecting devices can be arranged in at least two adjacent cooling chambers.

It can further be provided within the scope of the invention that the deflecting device is inserted into a receiving opening of the housing part which is arranged in the region of the front side, wherein preferably the housing part can be covered on the front side by a cover part, and wherein the deflecting device can be arranged in the cover part. The deflecting devices can be detachably fixed in the cover part or can be simultaneously cast therewith.

Simple production is enabled when the cooling chambers are flow-connected to a cooling chamber arranged in an annular fashion in the region of the first front side between an initial area and an end area, with at least one deflecting device crossing the cooling chamber in an especially preferred way in the axial direction. The annular space can be arranged in the housing part or in the cover part.

The cooling effect or flow through the individual cooling chambers can be adjusted to the respective requirements by varying the cross sections and/or the axial extension of the deflecting devices. Furthermore, reduced heat dissipation can be achieved if a deflecting device is not arranged in each cooling chamber but only in thermally critical regions of the cooling channel arrangement.

An especially good cooling effect can be achieved when the deflecting device forms a separation edge in the region of an end facing the cooling chamber, with preferably a flow cross section defined between the separation edge and a wall base of the cooling chamber being larger than a flow cross-section in the annularly arranged cooling chamber. This leads to stalls in the flow and turbulent flow, which supports the transport of heat.

### DRAWINGS

The invention will be explained below in closer detail by reference to the drawings, which schematically illustrate as follows:

FIG. 1 illustrates an electric generating unit with an electric machine in accordance with the invention.

FIG. 2 illustrates a cylindrical housing part in a sectional view along the line II-II.

FIG. 3 illustrates the cylindrical housing part in a front view.

FIG. 4 and FIG. 5 illustrate a cooling channel arrangement on the electric side in a respective oblique view.

FIG. 6 illustrates the cylindrical housing part in an oblique view.

FIG. 7 illustrates the cylindrical housing part in a further oblique view.

### DESCRIPTION

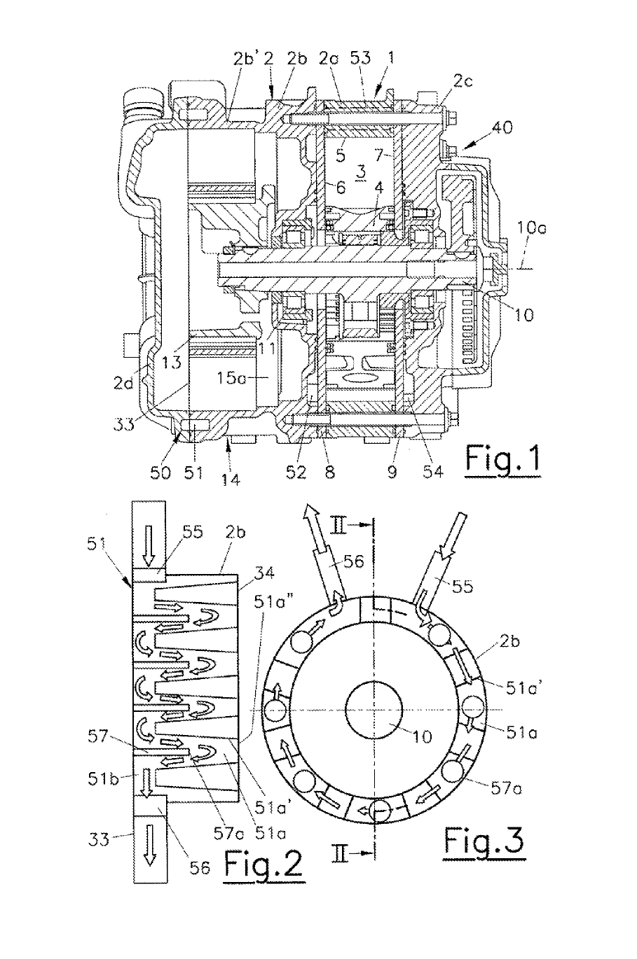

FIG. 1 illustrates a current generating unit 40 (range extender), especially for extending the range of an electric vehicle, with a rotary-piston engine 1 and an electric machine 14 which is excited by permanent magnets for example being arranged in a housing 2. The housing 2 comprises a chamber 3 in which a rotary piston is revolvingly arranged along a trochoidal running surface 5 of the housing 2. The chamber 3 is formed by the trochoidal running surface 5 and by lateral running surfaces 6, 7. The housing 2 comprises a central housing part 2a forming the trochoidal running surface 5, lateral housing parts 2b and 2c and, in the embodiment, the lateral plates 8, 9 which define the central housing part 2a.

An eccentric shaft 10 which is arranged in an inner housing space 15 in each of the housing parts 2b, 2c and which is driven by the rotary piston 4 is rotatably held via bearings 11, 12 which are arranged as rolling bearings for example. The rotor 13 of the electric machine 14 which is arranged in the same housing 2 is arranged coaxially to the eccentric shaft 10.

The lateral first housing part 2b which accommodates the bearing 11 comprises a bell-shaped cylindrical jacket area 2b, which opens a substantially cylindrical interior space 15a in which the rotor 13 and the stator 14a of the electric machine are arranged. The cylindrical interior space 15a is closed off by a cover part 2d adjacent to the housing part 2b.

The electric machine 14 and the rotary-piston engine 1 have a common cooling system 50, with the flow successively passing through the cooling channel arrangements 51, 52, 53, 54 which are provided in the housing parts 2d, 2b, 2a and 2c. As a result, the electric machine 14 and then the rotary-piston engine 1 will be cooled successively. A cooling chamber 51b of the cooling channel arrangement 51 on the electric side, which cooling chamber is arranged in an annular way between an initial area 55 and an end area 56, can be formed partly by the cover part 2d and partly by the cylindrical housing part 2b.

A number of cooling chambers 51a which extend in the direction of the axis 10a of the eccentric shaft 10 are arranged in the housing part 2b in the region of the electric machine 14, which cooling chambers are flow-connected to the annular cooling chamber 51b in the region of the front side 33 of the housing part 2b.

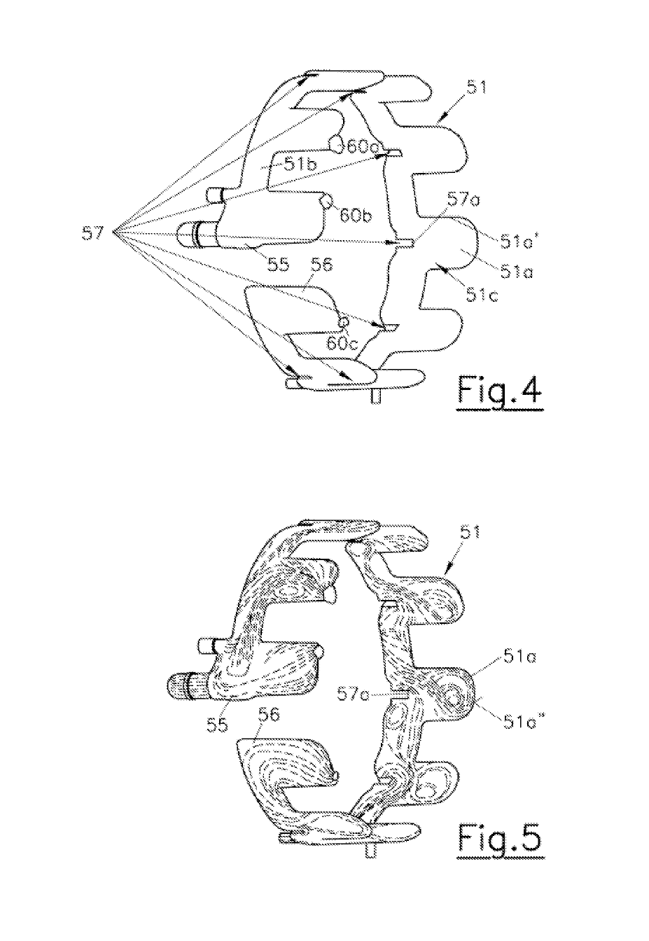

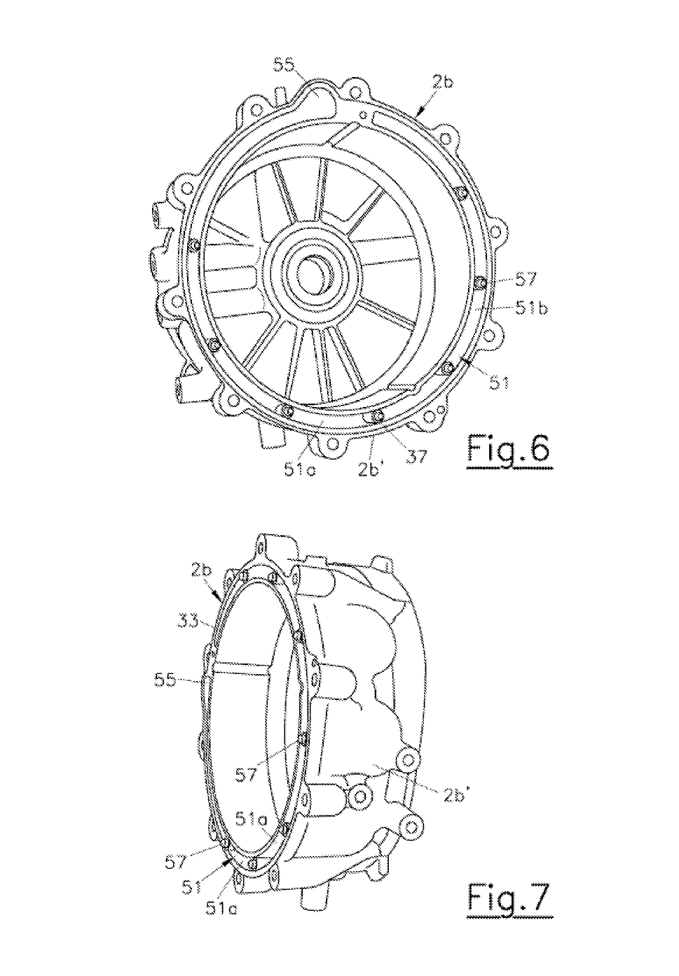

FIGS. 2 to 5 schematically illustrate a cooling channel arrangement 51 of the housing part 2b on the electric side, with the coolant entrance into the cooling chamber arrangement occurring in the initial area 55 and the coolant outlet in the end region 56 for example. The coolant can also be supplied and/or discharged at other locations of the coolant arrangement 51, e.g. in the region of a cooling chamber 51 such as in the region of the piston-side front side 36 of the housing part 2b. With the exception of optional inflow, outflow or transfer openings in other housing regions, the cooling chambers 51 a are substantially closed in the region of the piston-side front side 34 (e.g. by casting or by a cover part), so that forced deflection will occur at the end of each cooling chamber 51a.

In FIG. 2, the end area 56 is twisted into the plane of intersection and downwardly for illustrating the meandering flow of the coolant which is indicated by the arrows.

In order to enable a meandering coolant flow which is optimal for the cooling of the electric machine 14 in the cylindrical jacket area 2b′ of the housing part 2b which encloses the stator 14a and the rotor 13, deflection devices 57 are axially inserted into the cooling chambers 51a, which deflection devices 57 can be formed for example by plugs 57a, guide ribs or the like. The deflecting devices 57 are inserted for example in co-cast axial receivers 37 in the annular cooling chamber 51b. It is also possible as an alternative to this to arrange the deflecting devices 57 in the cover part 2d in a releasable or non-releasable manner (e.g., by co-casting).

The coolant which flows in the circumferential direction into the annular cooling chamber 51c will be deflected by the defecting devices 57 in the direction of axis 10a into the cooling chambers 51 a and returned along the walls 51a′ back to the cooling chamber 51, where it is deflected again by the next deflecting device 57 into the next cooling chamber. As a result of this loop-like movement of the coolant, the cooling area of the housing part 2b which is relevant for the electric machine 14 will be cooled evenly, wherein fine tuning of the heat dissipation can occur by changing the cross-section and/or the length of the deflecting devices 57. The deflecting devices 57 can consist of plastic or the like for example.

FIG. 5 illustrates the streamlines of the coolant flow in the loop-like annular chamber 51c. The deflecting devices 57 are only very few, i.e. they are inserted into the cooling chambers 51a to an extent that corresponds approximately to the axial extension of the annular chamber 51b. The deflecting device 57 forms a separation edge 57a, with a flow cross-section defined between the separation edge 57a and the wall base 51a″ of the cooling chamber 51a being larger than a flow cross-section in the annularly arranged cooling chamber 51b. The illustration illustrates that this leads to stalls in the flow and swirling phenomena in the cooling chambers 51a, by means of which the transport can be improved in these areas.

The deflecting devices 57 which can be moved into the annular cooling chambers 51 allow a meandering coolant flow in the housing part 2b which encloses the electric machine 14 by means of simple production and therefore the best possible heat dissipation.

1-13. (canceled)

14. An electric machine for an electric vehicle, comprising:
a cylindrical housing having at least one cooling channel arrangement through which a coolant flows, the cooling channel arrangement comprising a plurality of cooling chambers which extend substantially parallel in an axial direction and which are provided with an open configuration on at least one first front side of the cylindrical housing, with at least one cooling chamber being defined by walls extending substantially in the axial direction, and a deflecting device spaced from the walls and configured for at least partial arrangement into at least one of the cooling chambers;
a stator configured for arrangement in the cylindrical housing; and
a rotor configured for arrangement in the cylindrical housing.

15. The electric machine of claim 14, wherein the deflecting device comprises a plug and/or a guide element.

16. The electric machine of claim 14, wherein the deflecting device is detachably arranged in the at least one of the cooling chambers.

17. The electric machine of claim 14, wherein the walls are spaced in the axial direction from the at least one first front side.

18. The electric machine of claim 14, wherein the cylindrical housing has a receiver arranged in a region of the at least one first front side.

19. The electric machine of claim 18, wherein the deflecting device is received by the receiver of the housing.

20. The electric machine of claim 19, further comprising a cover configured to cover the housing in the region of the at least one first front side.

21. The electric machine of claim 20, wherein the deflecting device is configured for at least partial arrangement into the cover part.

22. The electric machine of claim 21, wherein the cooling chambers are fluidically connected to a second cooling chamber arranged annularly in the region of the first front side between an initial area and an end area.

23. The electric machine of claim 22, wherein the deflecting device is configured to cross the second cooling chamber in the axial direction.

24. The electric machine of claim 14, further comprising a second deflecting device configured for at arrangement in an adjacent one of the cooling chambers from the deflecting device.

25. The electric machine of claim 24, wherein the second deflecting device has a different cross-section than the deflecting device.

26. The electric machine of claim 24, wherein the second deflecting device has a different axial extension than the deflecting device.

27. The electric machine of claim 23, wherein the deflecting device forms a separation edge with a flow cross-section defined between the separation edge and a wall base of the first cooling chambers being greater than a flow cross section in the second cooling chamber.

28. The electric machine of claim 14, wherein the first cooling chambers are arranged in a region of a second front side of the housing part facing away from the deflecting device.

29. A current generating unit for an electric vehicle, comprising:
a housing;
an internal combustion engine configured for arrangement in the housing; and
an electric machine configured for arrangement coaxially with the internal combustion engine in the housing, the electric machine having a second housing with at least one cooling channel arrangement through which a coolant flows, the cooling channel arrangement comprising a plurality of cooling chambers which extend substantially parallel in an axial direction and which are provided with an open configuration on at least one first front side of the housing, with at least one cooling chamber being defined by walls extending substantially in the axial direction, and a deflecting device spaced from the walls and configured for at least partial arrangement into at least one of the cooling chambers;
a stator configured for arrangement in the cylindrical housing; and
a rotor configured for arrangement in the cylindrical housing.

30. An electric machine for an electric vehicle, comprising:
a housing;
a cooling channel arrangement in the housing through which a coolant flows, the cooling channel arrangement having cooling chambers on a front side of the housing, wherein at least one cooling chamber is defined by axial walls;
a deflecting device spaced from the walls and configured for at least partial arrangement into at least one of the cooling chambers;
a stator configured for arrangement in the housing; and
a rotor configured for arrangement in the housing.
